(19) United States
(12) Patent Application Publication
(10) Pub. No.: US 2010/0078572 A1
(43) Pub. Date: Apr. 1, 2010

(54) ANALYSIS OF LOW MOLECULAR WEIGHT MOLECULES BY MALDI-MS

(75) Inventors: Guenther Bonn, Zirl (AT); Rania Bakry, Innsbruck (AT); Christian W. Huck, Innsbruck (AT); Rainer Vallant, Innsbruck (AT); Zoltan Szabo, Pecs (HU)

Correspondence Address: Workman Nydegger;1000 Eagle Gate Tower, 60 East South Temple, Salt Lake City, UT, 84111, US

(73) Assignee: UNIVERSITAET INNSBRUCK, Innsbruck (AT)

(21) Appl. No.: 12/531,832

(22) PCT Filed: Mar. 19, 2008
(86) PCT No.: PCT/AT08/00098

§ 371 Date: Dec. 11, 2009

(30) Foreign Application Priority Data
Mar. 20, 2007 (EP) 07450051.3

(51) Int. Cl. B01D 59/44

(52) U.S. Cl. 250/382; 977/881; 977/847; 977/890

(57) ABSTRACT

The invention relates to a process for the analysis of molecules having a molecular weight of <1500 Da by matrix-assisted laser desorption/ionization mass spectrometry (MALDI-MS), wherein an analyte containing low molecular weight molecules is applied to a matrix material, which is characterized in that the matrix material comprises fullerene-derivatised silica. This process allows clear identification of small molecules through intensive signals without matrix -related background disturbances.

The present invention relates to a process for the analysis of molecules having a molecular weight of <1500 Da by matrix-assisted laser desorption/ionization mass spectrometry (MALDI-MS), wherein an analyte containing low molecular weight molecules is applied to a matrix material.

In spite of the growing acceptance of matrix-assisted laser desorption/ionization time-of-flight (MALDI-TOF) mass spectrometry (MS) for biomolecule analysis, its use in small molecule analysis and tandem MS experiments was limited. This is chiefly due to interference from matrix molecules and/or issues with uniform energy transfer from matrix to analyte upon UV laser excitation. Further, known matrices are specific for certain molecules, which is an obstacle to rapid analysis of a diverse set of samples.

Matrix-assisted laser desorption/ionization for the analysis of biomolecules was first introduced by Karas and Hillenkamp [1]. In this important contribution, matrix materials consisting of organic compounds were applied for the ionization of biologically important molecules which do not absorb UV effectively. Organic matrices are popular due to their simple handling and their ability to absorb UV-radiation and to ionize a diverse range of biomolecules such as proteins, peptides, lipids, sugars and DNA.

In spite of the fact that conventional matrices such as CHCA (α-cyano-4-hydroxycinammic-acid) and SA (sinapinic acid) can be used for the desorption and ionization of a multitude of analytes, the use of these matrices shows some drawbacks. They can cause a matrix-related background, especially in the low mass range, which is well known to decrease the sensitivity when analysing small molecules [2]. Due to the importance of the determination of low molecular weight (LMW) molecules, some efforts have been made to prepare matrix materials which avoid the unexpected matrix-related background.

Several attempts were made to use particles for the ionization of analytes. Tanaka et al. introduced the use of cobalt nano-powder [3]. The authors reported as desirable features of this material, among others, the high photo-absorption and the high surface area per particle. Sunner et al. [4] reported that the so-called surface-assisted desorption/ionization (SALDI), employing graphite powder in glycerol, is useful for the ionization of proteins and peptides. In Sunner's case the particle size was 1000 times higher than the cobalt particles applied by Tanaka. This fact confirmed that ionization might occur through a bulk desorption process.

Other inorganic materials such as a silver film consisting of very fine particles were used to ionize LMW molecules and peptides. The sensitivity was improved considerably by using a combination of silver particles with the analytes [5]. The authors proved that the particle size is not always a crucial factor for the laser desorption process. The inorganic particles need to have low atomic masses (lower than 1000 Da) and show high stability during the ionization process, however.

In another approach, Peterson and co-workers introduced and described some polymer monoliths which can be successfully applied to a typical MALDI target in order to get an interference-free matrix material for the laser desorption/ionization mass spectrometry of small molecules [6] including drugs, explosives and acid labile compounds. Monoliths were prepared with a pore size of 200 nm, which were found to be ideal for the analysis of small molecules. The efficiency of the desorption/ionization is influenced by several effects, among others the choice of solvent, the stability of the monolith matrix and of course the chemistry of a given material. Nevertheless porosity plays a crucial role in this procedure.

A significant improvement was achieved when Buriak et. al. developed the laser desorption/ionization on porous silicon (DIOS) for the analysis of LMW molecules [7]. Analytes are deposited on the porous surface of an etched silicon wafer. By applying porous silicon as a matrix the generation of ions is immensely enhanced due to the high surface area, optical absorption and the thermal conductivity of DIOS [8-11]. This technique offers good sensitivity, enabling measurements down to the low Pmol ranges for some small compounds, among others peptides from tryptic digest of BSA and ubiquitin, bradykinin thyrocalcitonin and conjugated steroids being present in urine samples. However, the etched silicon surface oxidizes rapidly and therefore the plate has to be used soon after the preparation.

This disadvantage of the porous silicon was further avoided by silylation of DIOS [12]. Silylated porous silicon exhibits a resistance to air oxidation and acid/base hydrolysis. Surface modification with the appropriate hydrophobic silanes allows analytes, coming from complex samples containing salts and other non-volatile interferences, to adsorb onto the surface. This means a rapid cleanup by simply spotting the sample onto the surface of the modified DIOS target. Even with the above mentioned modifications, the sensitivity for the analysis of peptides using DIOS is very high.

Silica gel is a prominent material and exhibits good abilities for different types of derivatisations. Moreover, the underivatised silica itself can generate ions from some analytes, due to its large surface area and thermal conductivity. After the silica had been derivatised with α-cyano-4-hydroxycinnamic acid (CHCA), the signal intensity of an analyte was found to be considerably higher than observed in the case of underivatised silica beads [13].

Pore size and preparation of the derivatised silica matrix including the choice of the appropriate solvent were both observed to be a crucial factor in the process of desorption/ionization. A better-defined porous film can be prepared using a sol-gel technique from a mixture of tetraethoxysilane and 2,4-dihydroxy benzoic acid (DHB) [14]. The incorporation of DHB in the film results in a background-free matrix interference.

Recently, an increasing attention has been paid toward the use of carbon materials to be employed as potential targets for bioanalysis [15-21]. Among the existing carbon nanomaterial one of the most popular and frequently used is the [C₆₀]fullerene and its derivatives because of their well defined structure, strong absorption in the UV region and high purity [15]. A water-soluble fullerene-based compound derivatised with carboxylic groups has lately been reported to be capable of forming solid particles with analytes having a narrow size distribution [22]. Particles were prepared by aerosolization, using a homemade collision atomizer from a solution containing the above mentioned fullerene-derivative and the analyte. The analysis of these particles with MALDI achieves a high sensitivity in the low Pmol range.

Sheia et al. reported the use of a previously synthetised hexa(sulfonbutyl)fullerene as an ion-pairing reagent for the selective precipitation of peptides being present in trace amounts in complex matrices [23]. The precipitation was then directly deposited on a target and analysed. This fullerene derivative serves not only as a precipitating agent but also as a matrix material in order to generate ions from analytes.

Sensitivity down to the attomole level has been achieved by using dense arrays of single-crystal silicon nanowires (SiNWs) [24]. It was found that considerably lower energy was required to desorb and ionize small molecules from the surface of the nanowires than from porous silicon.

Willet et. al. first reported applications of underivatised fullerenes as a MALDI matrix Although some proteins were successfully analysed on the surface of a thin fullerene film (˜10 nm thick) the method suffered from low sensitivity. This might be ascribed to the fact of the uneven dispersion of the polar analytes on the apolar fullerene film.

Accordingly, there is still a need to come up with a matrix material which obviates the above-mentioned disadvantages and overcomes the drawbacks of the known materials, particularly with regard to small molecules.

It is therefore the object of the present invention to provide a process for the analysis of molecules by matrix-assisted laser desorption/ionization mass spectrometry (MALDI-MS), which is particularly suited for molecules having a molecular weight of <1500 Da and allows clear identification through intensive signals in the spectra. In particular, matrix-related background disturbances should be avoided, while the desorption/ionization characteristics required for this technique are to be retained.

This object is achieved by a process for the analysis of molecules having a molecular weight of <1500 Da by matrix-assisted laser desorption/ionization mass spectrometry (MALDI-MS), wherein an analyte containing low molecular weight molecules is applied to a matrix material, characterized in that the matrix material comprises fullerene-derivatised silica.

According to a preferred embodiment, the fullerene-derivatised silica is selected from the group consisting of a fullerene-bonded silica resulting from the reaction of aminopropyl silica and [60]fullerenoacetyl chloride and a fullerene-bonded silica resulting from the reaction of aminopropyl silica and [60]epoxy fullerene.

Preferably, the silica has a pore size in the range of 0 (=non-porous)−100 nm, preferably 30 nm.

It is likewise preferred that the fullerene-derivatised silica has an increased specific surface area relative to silica alone.

In another preferred embodiment, the matrix material is prepared by suspending the fullerene-derivatised silica in a solvent, applying the suspension to a MALDI target and drying the matrix material, wherein the solvent is preferably selected from the group consisting of methanol, acetone, acetonitrile and a mixture of acetonitrile and water.

Thus, according to the invention, the advantageous of [C₆₀] fullerene and of silica gel have been combined. Silica gels with different porosity are regarded to be an ideal target support for chemical derivatisation. Due to the high reactivity of both silica gel and fullerene, several coupling reactions can be accomplished between silica gel and derivatives of fullerene. In this application two different methods are described. As a result, fullerene molecules were immobilised on the surface of silica gel and used as a matrix for the analysis of smaller, (<1500 Da) biologically important molecules such as sugars, peptides, amino acids and lipids.

Fullerene-derivatised silica materials were prepared by the inventors by means of introducing two different derivatisations. Results obtained from elemental analysis and BET measurement showed no differences between the yielded products. Derivatisation with fullerene was expressed in the increased surface area, indicating the presence of a relatively high number of fullerene molecules on the surface of the materials. Pore size and surface area both were found to be an essential factor in the desorption/ionization process. While from the larger pores the analytes are capable of desorbing easier, high enough surface is needed, however, to allow the laser energy to be forwarded from the fullerenes to the analytes.

Derivatives made from silica of 30 nm pore size were found to have the best properties for LDI analyses of small molecules. These materials are useful for the measurement of small molecules in low pmol range, eliminating the matrix-related background disturbances. Analysis of a large scale of small molecules with different polarities has successfully been performed. Identifications were enabled by intensive signals in the spectra given by the sodium and potassium adducts of the analytes. The use of fullerene-derivatised silica thus allows to determine compounds from different important biological samples.

The invention will be illustrated and described in more detail by way of the following examples.

### EXAMPLES

### Chemicals and Reagents

[C60]-Fullerene (≧99.5%) was purchased from MER Corporation (Tucson, Ariz., USA), sodium hydride (60%, dispersion in mineral oil), t-butyl bromoacetate (99%), dimethyl sulphide (99%), p-toluene sulfonic acid (97%), triethylamine (99.5%), trimethoxy-aminopropyl-silane (97%), thionyl chloride (≧99%), 3-chloroperoxybenzoic acid (70-75% balance), α-cyano-4-hydroxycinnamic acid (CHCA, ≧99.0%), D-lactulose (≧95%), D-lyxose (≧99.0%), glucose (≧99.5%), D-saccharose (≧99.5%), deoxycholic acid (≧99%), L-alanine (≧98%), L-lysine (≧98%), bradykinin (≧96.0%), angiotensin I (≧90%), valine-valine (≧99%) from Sigma-Aldrich, (St. Louis, Mo., USA). Sodium sulphate anhydrous (99%), toluene (99%), tetrahydrofuran (THF) (≧99.9%), silica gel 60 (pore size 60 Å, 200-425 mesh), alanine-alanine (≧99.0%), glycine-glycine-glycine (≧98.5%), methanol (≧99.8%, gradient grade) were obtained from Fluka (Buchs, Switzerland). 1,2-Diheptadecanoyl-sn-glycero-3-[phospho-rac-(1-glycerol)] was obtained from Avanti Polar Lipids (Alabaster, Ala., USA).

Kovasil 100A-5 (100 Å, 5 μm) silica gel was purchased from Zeochem A G (Uetikon, Switzerland); GromSIL 1000 Si (1000 Å, 5 μm) silica gel was obtained from Grom Analytik (Rottenburg-Hailfingen, Germany); ProntoSil 300-5-Si (300 Å, 5 μm) and Prontopearl SUB 2 NPP Si (non-porous, 1.5 μm) were from Bischoff Chromatography (Leonberg, Germany).

### Instrumentation

Elemental analysis of the derivatised fullerenes was carried out on a Carlo Erba EA 1110 CHNS instrument (Carlo Erba Reagents, Rodano, Italy). BET measurements were carried out using a home built device. All experiments were performed on a MALDI-TOF/MS instrument (Ultraflex, MALDI-TOF/TOF, Bruker Daltonics, Bremen, Germany) equipped with a 337 inn nitrogen laser. Analytes were deposited on stainless steel targets (MTP 384 target ground steel TF, Bruker Daltonics). An acceleration voltage was applied in the range of +30/−25 kV. 500 shots were summarised for each spectrum.

### Preparation of Aminopropyl-Bonded Silica

The synthesis of aminopropyl-bonded silica was carried out similarly to the method proposed by Jaroniec [27] with a slight modification. Prior to the reaction the silica gels were dried at 120° C. for 15 h to remove physisorbed water. Then approximately 1 g silica was suspended in 10 ml dry toluene and the calculated amount of the silane reagent was added to the suspension in three-fold excess. The mixture was refluxed for 10 h and washed 2 times with 50 ml toluene, 1 time with 50 ml dichloromethane and 3 times with 50 ml methanol-water 1:1 (at the second step the mixture was refluxed for 1 h in order to hydrolyse the remaining, unreacted methoxy groups). Finally, the bonded phase was washed with 30 ml methanol and dried.

### Preparation of [C60]fullerenoacetyl Chloride

T-butyl(dimethylsulfuranylidene)acetate was prepared according to the method described previously [28]. The nucleophilicity of the resulting ylide enabled a rapid reaction with C60 fullerenes (500 mg, 0.7 mmol). The mixture of different products consisting of mono-, di- and triadducts was then separated by flash chromatography. The monosubstituted t-butyl [C60]fullerenoacetate (200 mg, 0.24 mmol) was collected separately and hydrolysed with p-toluenesulfonic acid (82 mg, 0.48 mmol) in the presence of dry toluene (150 ml) [29]. The brown solid ([60]fullerenoacetic acid, 135 mg, 0.18 mmol) was filtered and washed with toluene and water. [60] Fullerenoacetic acid (200 mg, 0.26 mmol) was reacted with thionyl chloride in excess (10 ml, 140 mmol) for 8 h under nitrogen. The excess of thionyl chloride was evaporated under vacuum and the resulting [60]fullerenoacetyl chloride (175 mg, 0.21 mmol) recovered.

Synthesis of [C60]epoxyfullerene

The oxidation of [C60]fullerene was carried out using a 10-fold molar exess of m-chloroperoxybenzoic acid (718 mg, 4.16 mmol) which was purified by washing with a PBS buffer (pH 7.4). The purified m-chloroperoxybenzoic acid was added to a heated solution (80° C.) of fullerenes (300 mg, 0.416 mmol) dissolved in 150 ml toluene [30]. After 12 h the toluene was evaporated and the resulting brown solid (consisting of unreacted fullerenes (60%), mono- (30%) and diepoxyfullerenes (10%)) was washed thoroughly with methanol to remove the excess of m-chloroperoxybenzoic acid and dried under high vacuum yielding 30%.

### Preparation of Fullerene-Silica

After the successful preparation of [C60]fullerenoacetyl chloride the material was immediately dissolved in dry THF (10 mL). 100 mg aminopropyl-bonded silica was added to the solution and the mixture was brought to boil. Calculated on the basis of the numbers of amino groups obtained from elemental analysis, 3-fold excess of [C60]fullerenoacetyl chloride was taken to ensure efficient reaction. Shortly after beginning of reflux, triethylamine was added (in 2-fold excess in comparison to the amount of [C60]fullerenoacetyl chloride) to bind the developing hydrogen chloride. The mixture was refluxed under argon for 10 h and finally the fullerene-bonded silica was purified, initially by washing and refluxing in THF, then by refluxing in a mixture of methanol and water (1:1) to ensure the hydrolysis of the unreacted [C60]fullerenoacetyl chloride. Finally the product was washed with THF and dried. FIG. 1 shows the derivatization of aminopropyl silica using [C60]fullerenoacetyl chloride.

FIG. 1(a² and b²) also illustrates the synthesis of fullerene-silica applying [C60]epoxyfullerene. To carry out the synthesis the resulting product (consisting of mono- and diepoxyfullerenes and unreacted fullerene) was dissolved in 150 ml toluene. 100 mg aminosilica having a pore size of 300 Å was added and the solution was refluxed for 12 h. After centrifugation, the derivatised silica was thoroughly washed with toluene until the supernatant showed no further trace of contamination. In order to remove unreacted chemically non-bonded fullerenes, the product was once more suspended in 150 ml toluene and refluxed for another 6h.

The fullerene-derivatised silica materials prepared according to the above mentioned methods were suspended in methanol in a proper ratio and used for the analysis of a wide variety of small, biologically important compounds such as sugars, peptides, amino acids, etc.

### Pretreatment of Real Samples for MALDI Measurements

The ingredients of two products used in the medical practice were analysed by MALDI. Diastabol (Sanofi Winthrop, Wien, Austria) is used to treat type II of diabetes, particularly in people whose diabetes cannot be controlled by diet alone. One pill of Diastabol contains 50 mg miglitol. One pill from this remedy was grounded thoroughly in a mortar and the powder was dissolved in bidistilled water. This was followed by a filtration and finally the solution was analysed.

An infusion solution (Aminomel Nephro Infusion, Baxter Deutschland GmbH, Germany) consisting of 20 amino acids and other compounds (for example acetylcysteine and N-acetyltyrosine) was diluted 100-fold prior to analysis.

### Characterization of Fullerene-Derivatised Silica Materials

Fullerene-derivatised silica materials were made from silicas having different pore sizes (Table I). The amount of immobilized fullerenes on the surface of the silica and the surface area of the derivatised material as well as the pore size are all crucial factors in the desorption procedure.

The surface areas (see Table II) of the different materials measured by BET (Brunnauer-Emett-Teller method) show the effect of the derivatisation. In comparison to the surface area of the aminopropyl-bonded silica prepared from 10 nm pore size silica its fullerene-derivative shows only a slight increase (6%) in surface area. Taking into account the size of a fullerene molecule (7 nm) it is obvious that into smaller pores (10 nm) fullerenes can hardly penetrate. By using silicas at higher average pore size (30 nm and 100 nm) this steric hindrance existing in case of small pores is immensely decreased and fullerene molecules are attached not only on the outer surface of particles but also inside the particles (on the walls of pores) as well.

This is clearly confirmed by measurements obtained for 30 nm and 100 nm pore size aminopropyl-bonded silica and their fullerene-derivatives. As can be seen, silica having an average pore size about 30 nm and surface area of 79.7 m²/g can yield a fullerene-derivative with a surface area of about 116 m²/g. This means that derivatisation resulted in an increased surface area for derivatives made from large pore silicas.

The increase of the surface area was found to be about 45% in case of 30 nm pore size silica and 33% for 100 nm pore size silica. These results allow to conclude that, due to the nanometer size of fullerenes, their surface can considerably contribute to the surface area of the derivatives. In the desorption/ionization process the surface area from which the analytes are desorbed as well as the pore structure of the silica play an important role. The most increased surface indicates that the attached fullerenes are present in the highest number on the surface of the support (silica) allowing the material to have excellent properties for the MALDI analysis of compounds. By comparing the two different syntheses described herein, no differences could be observed with regard to the surface area and the carbon coverage of the resulting products.

Surface coverages of the derivatives for the ligands being attached to the surface of the material can be calculated according to the equations reported in the literature [27]. The results are summarised in Table II. The surface coverage of the derivatives increases with increasing pore diameter of the silica material. However, the accessibility of the small molecules of the applied silane is not restricted even in case of the 10 nm pore diameter silica gel.

After the derivatisation of amino phases made from silicas having different pore sizes with [C60]fullerenoacetyl chloride the resulting materials possess prominent differences in surface coverage. As it is expected, the highest value of the surface coverage (2.27 μmol/m²) was obtained by the material prepared from 100 nm pore size silica. While surface coverages of 30 nm fullerene-silica material was found to be considerably lower (1.67 ᵢmmol/m²), silica material having a pore diameter about 10 nm yields only 0.88 μmol/m² surface coverage of the amide bonded fullerene ligands. Further measurements based on mercury porosimetry (data not reported) confirmed that the resulting derivatives obtained from 10 nm silica totally loses the pore volume because pores are clogged up by the bulky fullerene molecules.

Although the highest surface density of the fullerene-containing ligands was monitored for 100 nm pore size, this material has a rather low surface area (32 m²/g). Observations from LDI measurements support the fact that not only the amount of chromophore being attached to the surface of solid support but the surface area of the material play also a crucial role through LDI.

As can be seen from Table II, derivatisation of amino phase made from 30 nm pore size silica with [C60]epoxyfullerene results in higher surface coverage than the corresponding derivative prepared by means of the [C60]fullerenoacetyl chloride derivatisation method. This can be ascribed to the fact that the stability and therefore the reactivity of the [C60]epoxyfullerene might be better. However, no further studies upon the confirmation of this assumption have been done.

### MALDI Analyses of Low Molecular Weight Molecules Using Fullerene-Silica

The fullerene-derivatised silica was used for the analysis of several small molecules. To carry out a successful analysis, the silica-based materials had to be suspended in a proper solvent and 1 μL from the suspension was carefully placed on a stainless steel target and dried. Several solvents were tried to obtain a fullerene-silica suspension, among others acetone, acetonitrile, a mixture of acetonitrile and water and methanol. Methanol was found to be most appropriate to generate a very thin layer from the suspension which is consistent with the result reported by Zhang et al. [17].

Another important requirement was to find the proper ratio of methanol and material. 0.5 mg of the fullerene-silica was suspended with 200 μL methanol and put in an ultrasonic bath for 10 minutes. This ratio was applied at all measurements performed. Reproducibility of the sample preparation was confirmed.

Derivatisation of silicas has been accomplished by reaction with either [C60]fullerenoacetyl chloride or [C60]epoxyfullerene, resulting in materials with the same properties, as it has been shown by the results obtained from elemental analysis and BET measurements. It was confirmed that, although the chemical structures of the derivatives, especially the spacers between the silica and the fullerene are different, the slight difference between the structures has no influence on the analysis of the investigated compounds. The desorption/ionization of 100 pmol saccharose yielded sodium and potassium adducts at m/z 365.07 and 381.05 with comparable intensity using fullerene-silicas yielded from the two derivatisations.

The most important disadvantage of using UV-absorbing organic matrices such as sinapinic acid and 2,4-dihydroxy-benzoic acid is the matrix-related background noise. This does not allow the analysis of compounds in low mass range because of the interferences between the matrix and analytes. FIG. 2 demonstrates the analysis of a dipeptide (Val-Val) using fullerene-silica and CHCA matrix materials. The quite intensive sodium and potassium adducts (in general, more intensive than the protonated signal) makes the identification of the compound of interest easier. This is further demonstrated by the analysis of a real sample containing amino acids. The spectrum obtained by the use of CHCA, however, suffers from the presence of many matrix-related peaks.

Pore size of the silica support plays an important role in the desorption/ionization. As is demonstrated by FIG. 3, the analysis of angiotensin at a concentration of 80 pmol/μL was carried out using derivatives made from different pore size silicas. Silica itself is able to assist the desorption/ionization procedure due to its favourable properties. FIG. 3A shows the analysis of angiotensin I solution at a concentration of 80 pmol/μL using underivatised silica gel (ProntoSil 300-3-Si). Although a signal belonging to the analyte can clearly be identified, this spectrum exhibits considerable differences in comparison to spectra measured by using derivatised silicas. Signal-to noise ratio was found to be 17.25 and isotopic resolution of angiotensin I was about 8531.

In case of non-porous derivative no signal could be detected for angiotensin I and bradykinin. However, this material could be used to achieve the desorption of smaller molecules. The signal intensity as well as the signal-to-noise ratio (S/N) gave the highest values in case of the 30 nm pore size (FIG. 3C) derivative, 61 and 16859, respectively. Both the sodium and potassium adducts are present at m/z values of 1318.24 and 1334.55.

In case of the 10 nm fullerene-derivative (FIG. 3B), the intensity and S/N (30.23) are considerably lower compared to the 30 nm fullerene-silica material and the isotopic resolution was only 11831. This material possesses the highest surface area and consequently enables the molecules of an analyte to spread and interact more evenly on a large surface, but during the desorption/ionization the molecules are rather hindered to move out of the narrower pores. 100 nm pore size does not cause any steric difficulties for compounds to desorb from the surface. However, the low surface area and accordingly the smaller amount of fullerenes being attached to a relatively small surface are not as efficient to forward the laser energy toward the analyte, as it was observed at 30 nm. The S/N ratio was 45.56 and the isotopic resolution was lower (11438) than that of material made from 30 nm pore size silica. No sodium and potassium signals are observed (FIG. 3D). A sensitivity study was carried out for angiotensin I. and resulted in 8 μmol at S/N=5.

This fact is further confirmed by the analysis of bradykinin. Clearly, the highest signal intensity and signal-to-noise ratio could be achieved using 30 nm pore size fullerene-silica for desorption/ionization.

For the sensitivity study of the fullerene-silica materials the 30 nm pore size derivative was chosen. For L-lactulose 1 pmol could successfully be detected (FIG. 4). It is important to mention, that the analysis of carbohydrates results only in sodium and potassium adducts of the analyte. In general, the sodium and potassium ions are responsible for ionizing the molecules of carbohydrates. These observations are supported by experimental data obtained for D-glucose and D-lyxose. For instance, the detection limit of L-lactulose at S/N of 5 was achieved by the measurement of the signal of the potassium adduct.

Steroids and phospholipids with long hydrophobic fatty acid chains are belonging to the group of lipids. They are well known for their hydrophobic properties. Successful analysis of a phospholipid was carried out using fullerene-silica material (FIG. 5). Beside the intensive molecular peak, both sodium and potassium adducts were monitored. In case of the analysis of deoxycholic acid (FIG. 6) a mass shift was observed for the molecular peak (395.22 was monitored instead of 392.57).

Analysis and identification of the compounds of a complex sample means a challenging task. To introduce the applicability of the fullerene-silica material, two commercially available medicines were analysed. Besides showing the protonated peak in the spectrum, miglitol provides intensive sodium and potassium adducts at m/z 230.20 and 246.17 (FIG. 7).

FIG. 8 shows that 14 amino acids were successfully identified from the diluted infusion solution (Table III). The requirement of successful analysis was the capability of identifying at least two adducts of each amino acid. Amino acids possessed a weak protonated peak but the intensive sodium and potassium adducts enabled to distinguish the majority of compounds being present in the sample.

### DESCRIPTION OF FIGURES

FIG. 1 illustrates the derivatisation of silica gel employing two different reactions.

a¹: [C60]fullerenoacetyl-chloride
a²: [C60]epoxyfullerene.
b¹ and b² demonstrate the immobilization of [C60]fullerene-derivatives on aminopropyl bonded silica.

FIG. 2 shows the MALDI-spectra of a dipeptide (divaline, 100 pmol, Mw.: 216.28 Da) using

A.) 30 nm pore size fullerene silica
B.) α-cyano-4-hydroxycinnamic-acid (CHCA) as matrix. Spectra were summarised from 500 shots.

FIG. 3 illustrates the influence of the derivatisation and the pore size of the silica materials on desorption/ionization. Analyte: 80 pmol angiotensin I.

A.) underivatised ProntoSil 300-5-Si silica gel
B.) fullerene silica made from Kovasil 100A-5 silica gel
C.) fullerene silica made from ProntoSil 300-3-Si silica gel
D.) fullerene silica made from GromSIL 1000 Si silica gel.
Spectra were summarised from 500 shots. Resolution and signal-to-noise data are reported from a single spectrum.

FIG. 4 shows the MALDI-spectra of lactulose (Mw.: 342.3 Da)

A.) 100 pmol
B.) 1 pmol,
using 30 nm pore size fullerene silica.
Spectra were summarised from 500 shots.

FIG. 5 shows the MALDI-spectra of a phospholipid (Mw.: 773.02 Da, 1,2 Diheptadecanoyl-sn-Glycero-3-[Phospho-rac-(1-glycerol)]) on a 30 nm pore size fullerene-silica. Spectrum was summarised from 500 shots.

FIG. 6 shows the MALDI-spectra of deoxycholic acid (Mw.: 392.57 Da , 1000 ppm) using 30 nm pore size fullerene silica. Spectrum was summarised from 500 shots.

FIG. 7 shows the MALDI-spectra of miglitol (Mw.: 207.22 Da, 5 nmol) extracted from a commercially available medicine using 30 nm pore size fullerene-silica. Spectrum was summarised from 500 shots.

FIG. 8 shows the MALDI-spectra of “Aminomel Nephro Infusion”-solution (100-fold diluted) using 30 nm pore size fullerene-silica. 17 amino acids were successfully identified. Spectrum were summarised from 500 shots.

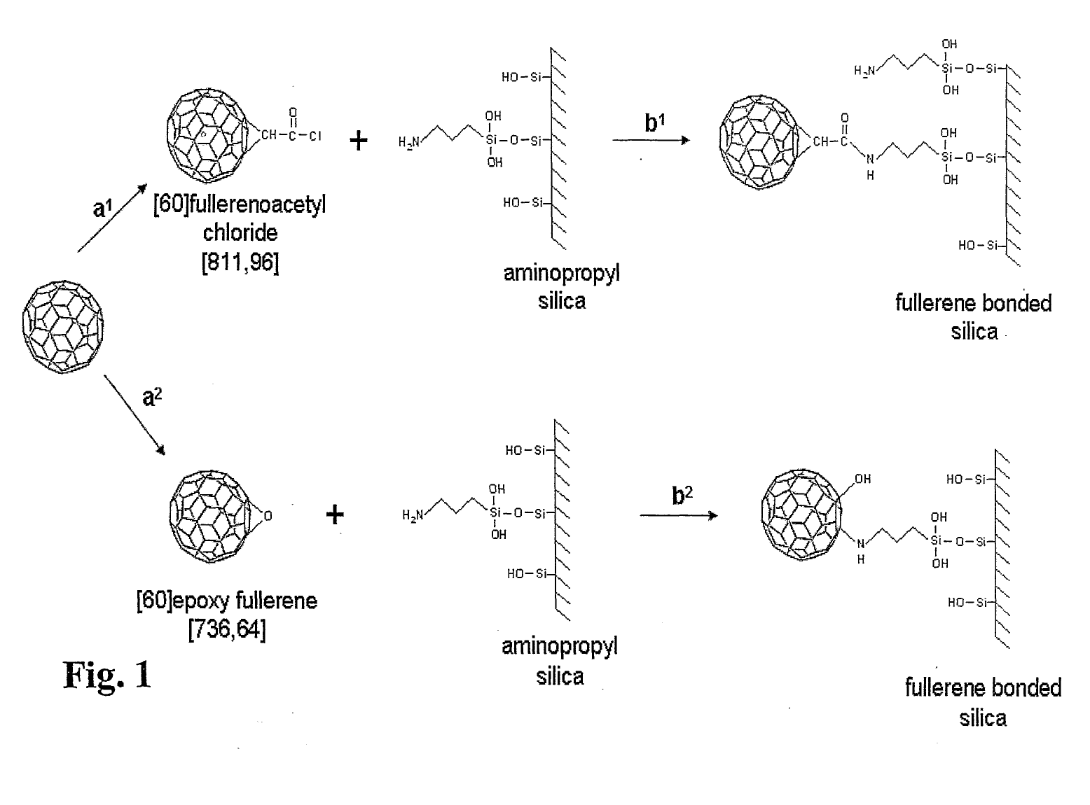

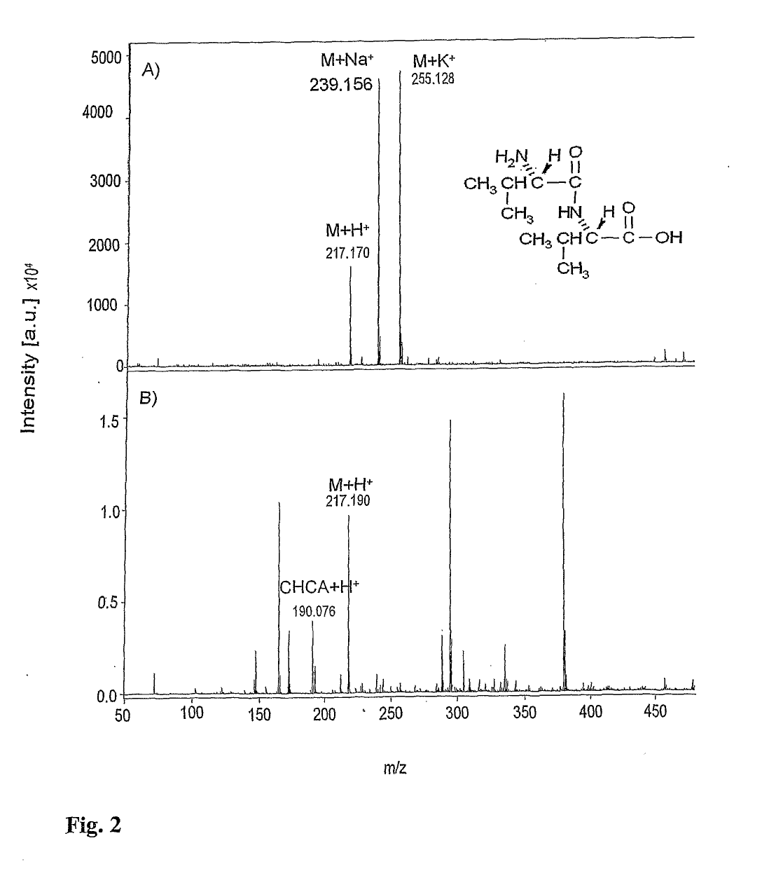

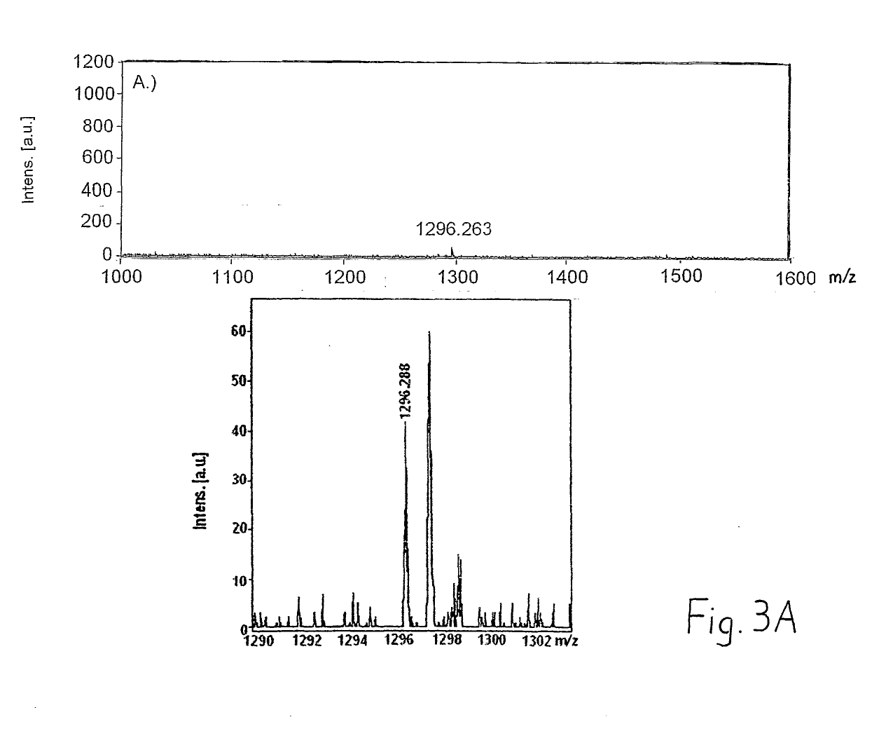

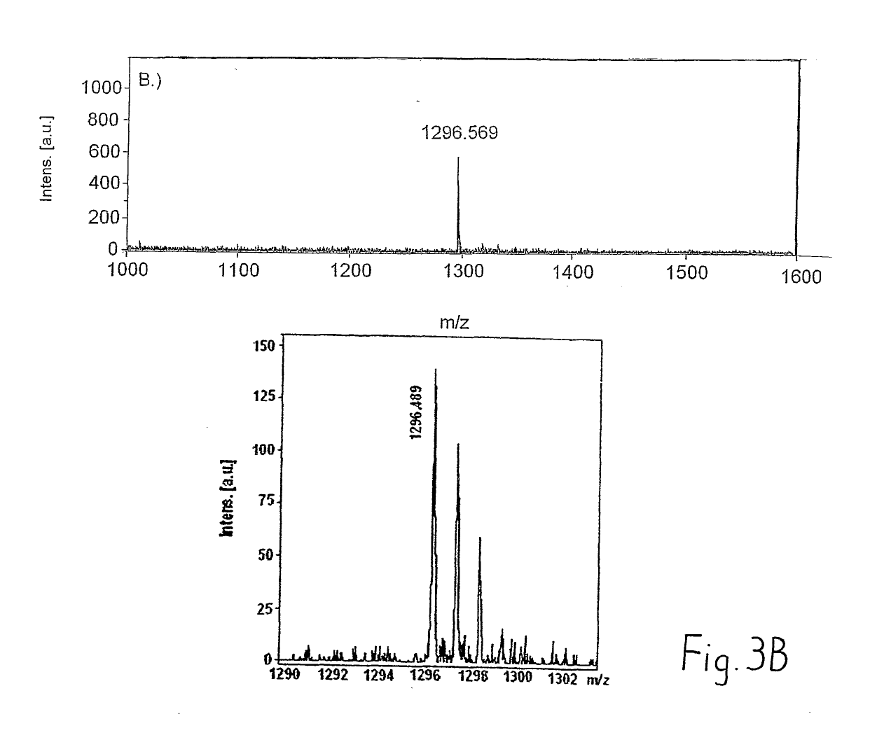

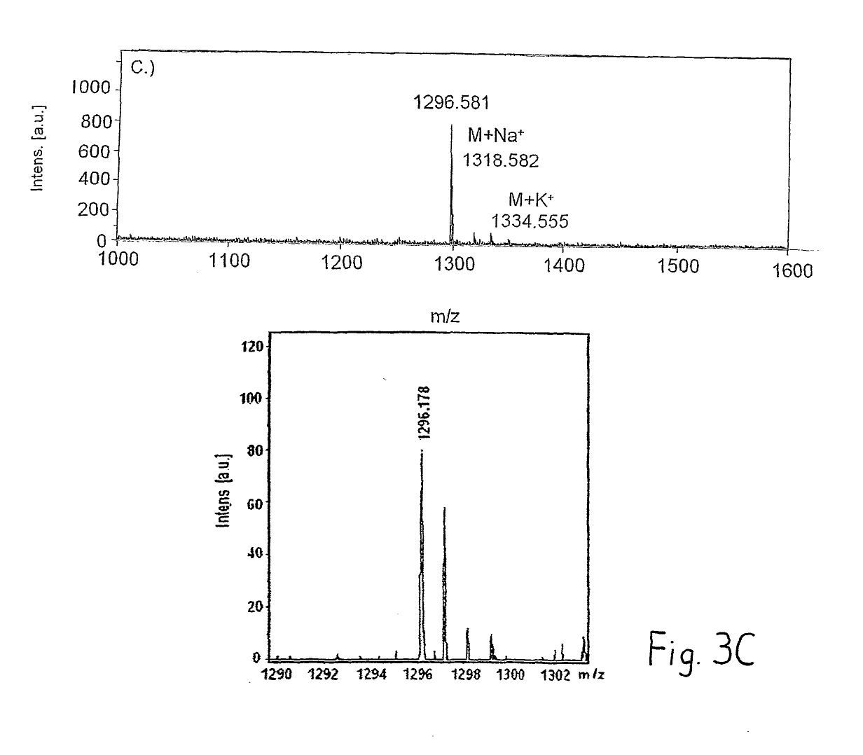

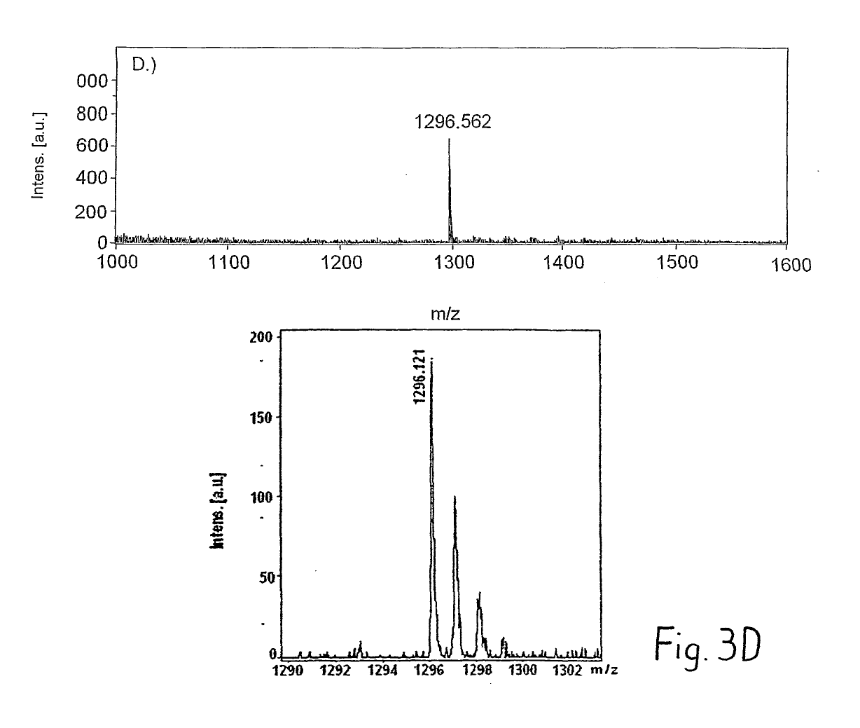

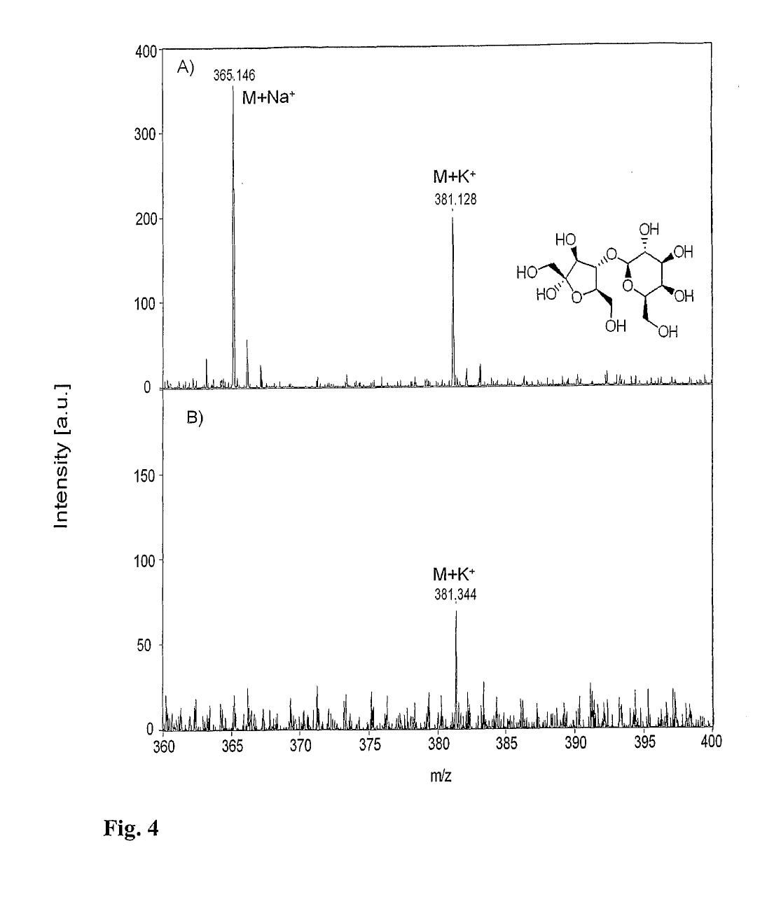

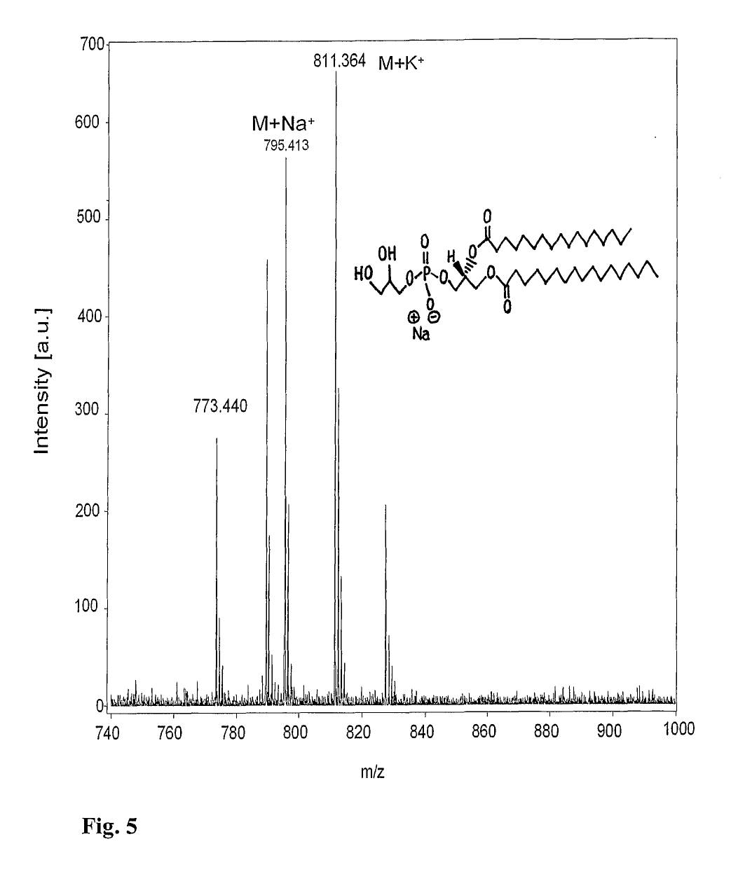

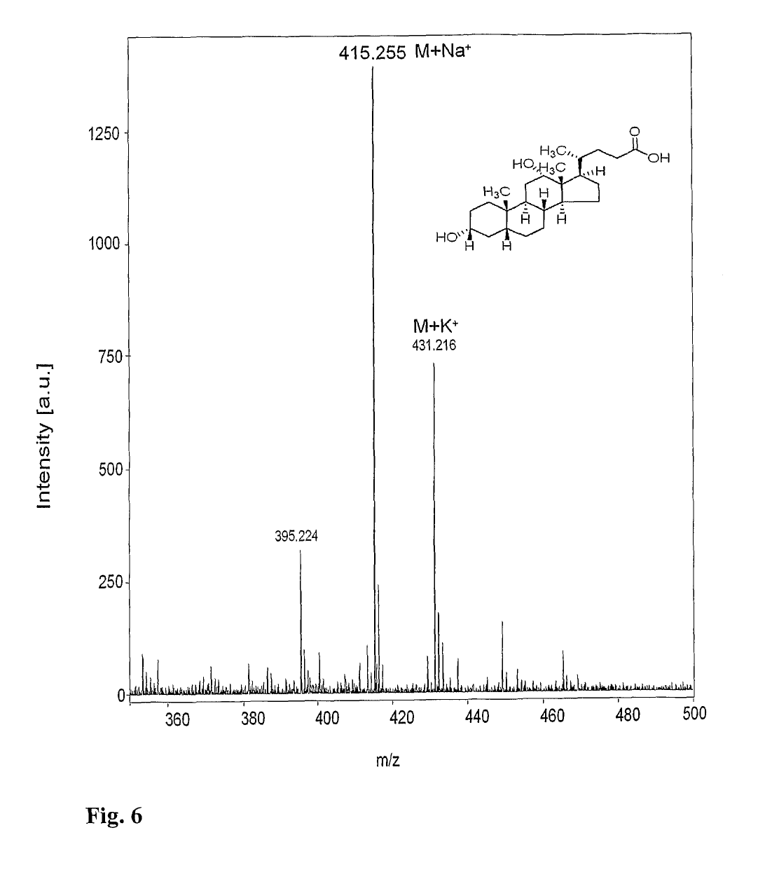

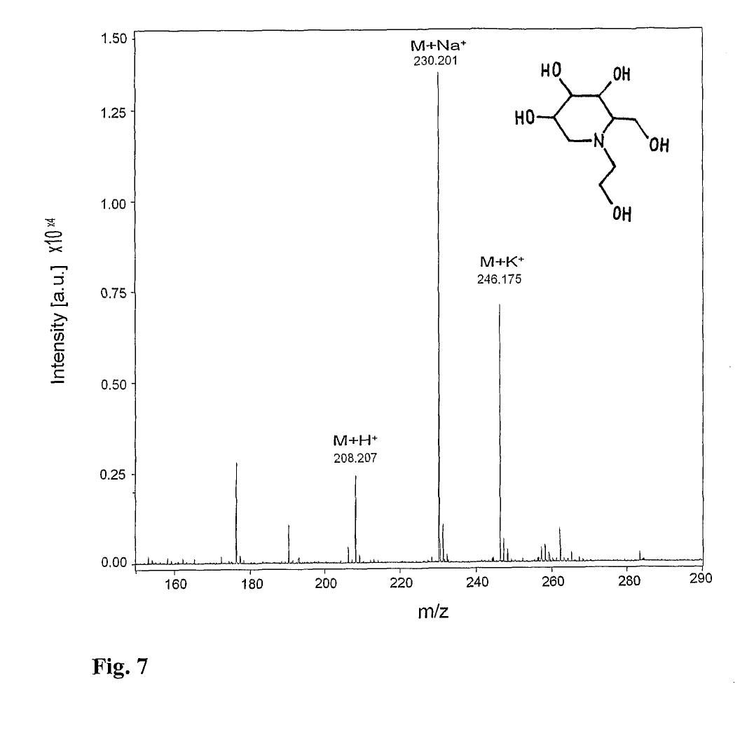

TABLE I
Characterisation of silica gels used in this study.
Data were given by the manufacturers

| | Particle | | | |
|---|---|---|---|---|
| | size | Surface area | Pore size | Pore volume |
| Name | (μm) | (m²/g) | (nm) | (cm³/g) |
| Kovasil 100A-5 | 5 | 305 | 10.1 | 0.77 |
| ProntoSil 300-5-Si | 5 | 100 | 30 | 1.05 |
| GromSIL 1000 Si | 5 | 30 | 10 | 1.1 |
| Prontopearl NPP | 1.5 | 3 | non-porous | 0 |

TABLE II
Characterisation of the aminopropyl silica and the fullerene derivatives.
ProntoSil 300-5-Si-C60(1) was synthethised from [C60]fullerenoacetyl
chloride and ProntoSil 300-5-Si-C60(2) was synthethised from
[C60]epoxyfullerene. All other derivatives were
synthethised using [C60]fullerenoacetyl chloride.

| | | Surface | Specific |
|---|---|---|---|
| | Carbon | coverage | surface |
| Name | content (%) | (μmol/m²) | area (m²/g) |
| Kovasil 100A-5-NH2 | 3.14 | 3.24 | 250 |
| Kovasil 100A-5-C60 | 16.82 | 0.88 | 265 |
| ProntoSil 300-5-Si-NH2 | 1.18 | 3.43 | 81.5 |
| ProntoSil 300-5-Si-C60(1) | 11.33 | 1.67 | 116 |
| ProntoSil 300-5-Si-C60(2) | 17.54 | 2.91 | 114 |
| GromSIL 1000 Si-NH2 | 0.39 | 3.66 | 23.9 |
| GromSIL 1000 Si-C60 | 5.01 | 2.27 | 32 |

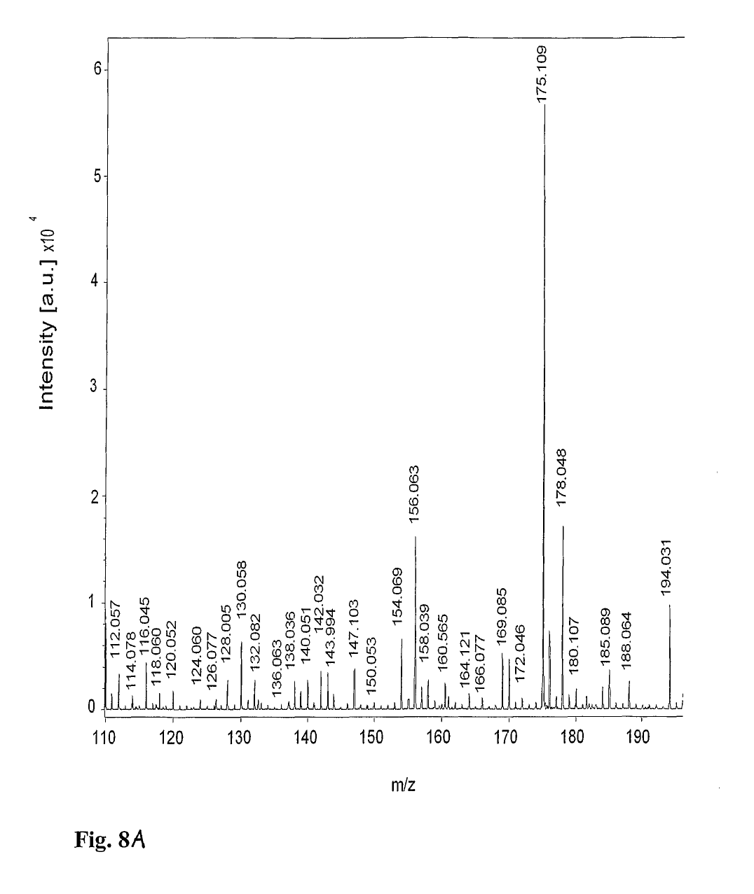

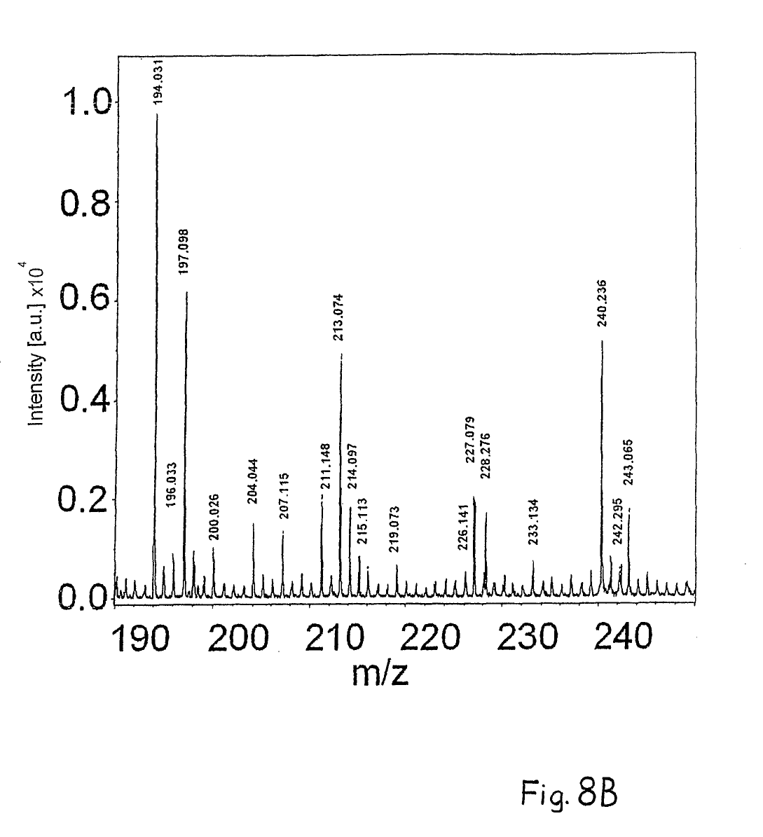

TABLE III
Amino acids being identified from 100 times diluted “Aminomel
Nephro Infusion”-solution using 30 nm pore size
fullerene-silica (see FIG. 8).

| Amino acids | M + H⁺ (m/z) | M + Na⁺ (m/z) | M + K⁺ (m/z) |
|---|---|---|---|
| Ala | | 112.057 | 128.005 |
| Arg | 175.100 | 197.098 | 213.074 |
| Asp | | 156.063 | 172.046 |
| Cys | | 143.990 | 160.565 |
| His | 156.063 | | 178.049 |
| Ile | 132.082 | 154.069 | |
| Leu | 132.082 | 154.069 | |
| Lys | 147.103 | 169.085 | 185.069 |
| Met | 150.053 | 172.076 | 188.064 |
| Phe | 166.077 | | 204.044 |
| Pro | 116.045 | 138.036 | 154.069 |
| Thr | 120.052 | 142.032 | 158.039 |
| Trp | | 227.079 | 243.065 |
| Val | 118.060 | 141.056 | |

### REFERENCES

[1] Karas, M.; Hillenkamp, F., Anal. Chem. 1988, 60, 2299-2301.
[2] Tomoya, K.; Takumi, S.; Mitsuo, T.; Haruki, N., J. Mass Spectrom. 2000, 35, 417-
[3] Tanaka, K.; Waki, H.; Ido, Y.; Akita, S., Rapid Commun. Mass Spectrom. 1995, 9, 126
[4] Sunner, J.; Dratz, E.; Chen, Y. C., Anal. Chem. 1995, 67, 4335-4342.
[5] Lai, E. P. C.; Owega, S.; Kulezycki, R., J. Mass. Spectrom. 1998, 33, 554-564.
[6] Peterson, D. S.; Luo, Q., Hilder, E. F.; Svec, F.; Fréchet, J. M. J., Rapid Commun. Mass Spectrom. 2004, 18, 1504-1512.
[7] Wei, J.; Buriak, J. M.; Siuzdak, G., Nature 1999, 399, 243-246.
[8] Shen, Z., Thomas, J. J.; Averbuj, C.; Broo, K. M.; Engelhard, M.; Crowell, J. E.; Finn, M. G.; Siuzdak, G., Anal. Chem. 2001, 73, 612-619.
[9] Thomas, J. J.; Shen, Z., Crowell, J. E.; Finn, M. G.; Siuzdak, G., Proc. Natl. Acad. Sci. U.S.A. 2001, 98, 4932-4937.
[10] Cuiffi, J. D.; Hayes, D. J.; Fonash, S. J.; Brown, K. N.; Jones, A. D., Anal. Chem. 2001, 73, 1292-1295.
[11] Kruse, R. A.; Li, X. L.; Bohn, P. W.; Sweedler, J. V., Anal. Chem. 2001, 73, 3639-3645.
[12] Trauger, S. A.; Go, E. P.; Shen, Z.; Apon, J. V.; Compton, B. J.; Bouvier, E. S. P.; Finn, M. G.; Siuzdak, G., Anal. Chem. 2004, 76, 4484-4489.
[13] Zhang, Q.; Zou, H.; Guo, Z.; Zhang, Q.; Chen, X.; Ni, J., Rapid Commun. Mass Spectrom. 2001, 15, 217-223.
[14] Lin, Y-S.; Chen, Y-C., Anal. Chem. 2002, 74, 5793-5798.
[15] Huang, J.; Wang, L.; Chiang, L.; Shiea, J., J. Fullerene Sci. Technol. 1999, 7, 541
[16] Shiea, J.; Huang, J.; Teng, C.; Jeng, J.; Wang, L.; Chiang, L., Anal. Chem. 2003, 75, 3587-3595.
[17] Li, J.; Takeuchi, A.; Ozawa, M.; Li, X.; Saigo, K.; Kitazawa, K.; J. Chem. Soc. Chem. Commun. 1993, 1748
[18] Woods, A. S.; Koomen, J.; Ruotolo, B.; Gillig, K. J.; Russel, D. H.; Fuhrer, K.; Gonig, M.; Egan, T.; Schultz, J. A., J. Am. Soc. Mass. Spectrom. 2002, 23, 166-169.
[19] Najam-ul-Haq, M.; Rainer, M.; Huck, C. W.; Stecher, G.; Feuerstein, I.; Steinmüller, D; Bonn, G. K., Curr. Nanosci. 2006, 2, 1-7.
[20] Najam-ul-Haq, M.; Rainer, M.; Schwarzenauer, T.; Huck, C. W.; Bonn, G. K., Anal. Chim. Acta. 2006, 561, 32-39.
[21] Valiant, R. M.; Szabo, Z.; Trojer, L.; Najam-ul-Haq, M.; Rainer, M.; Huck, C. W.; Bakry, R.; Bonn, G. K.; J. Proteome Res. 2006, accepted.
[22] Ugarov, M. V.; Egan, T.; Khabashesku, D. V.; Schulz, J. A.; Peng. H.; Khabashesku, V. N.; Furutani, H.; Prather, K. S.; Wang, H-W. J.; Jackson, S, N.; Woods, A. S.; Anal. Chem. 2004, 76, 6734-6742.
[23] Shiea, J.; Huang, J-P.; Teng, C-F.; Jeng, J.; Wang, L. Y.; Chiang, L. Y. Anal. Chem. 2003, 75, 3587-3595.
[24] Go, E. P.; Apon, J. V.; Luo, G.; Saghatelian, R. H.; Daniels, R. H.; Sahi, V.; Dubrow, R.; Cravatt, B. F.; Vertes, A.; Siuzdak, G., Anal. Chem. 2005, 77, 1641-1646.
[25] Michalak, L.; Fisher, K. J.; Alderdice, D. S.; Willet, G. D., Org. Mass. Spectrom. 1994, 8, 881
[26] Hopwood, F. G.; Michalak, L.; Alderdice, D. S.; Fisher, K. J.; Willet, G. D., Rapid Commun. Mass Spectrom. 1994, 8, 881.
[27] Jaroniec, C. P.; Gilpin, R. K.; Jaroniec, M., J. Chromatogr. A. 1998, 797, 103-110.
[28] Speziale, A. J.; Tung, C. C.; Ratts, K. W.; Yao, A. J. Am. Chem. Soc. 1965, 85, 3460-3462.
[29] Ito, H.; Tada, T.; Sudo, M.; Ishida, Y.; Hino, T.; Saigo, K. Organic Letters. 2003 5, 2643-2645.
[30] Balch, A. L.; Costa, D. A.; Noll, B. C.; Olmstead, M. M., J. Am. Chem. Soc. 1995, 117, 8926-8932.

1. A process for the analysis of molecules having a molecular weight of <1500 Da by matrix-assisted laser desorption/ionization mass spectrometry (MALDI-MS), the process comprising:
applying an analyte containing the low molecular weight molecules to a matrix material, characterized in that the matrix material comprises fullerene-derivatised silica.)

2. The process according to claim 1, wherein the fullerene-derivatised silica is selected from the group consisting of a fullerene-bonded silica resulting from the reaction of aminopropyl silica and [60]fullerenoacetyl chloride and a fullerene-bonded silica resulting from the reaction of aminopropyl silica and [60]epoxy fullerene.

3. The process according to claim 1, wherein the silica has a pore size in the range of 0-100 nm.

4. The process according to claim 1, wherein the fullerene-derivatised silica has an increased specific surface area relative to silica alone.

5. The process according to claim 1, wherein the matrix material is prepared by suspending the fullerene-derivatised silica in a solvent, applying the suspension to a MALDI target and drying the matrix material.)

6. The process according to claim 5, wherein the solvent is selected from the group consisting of methanol, acetone, acetonitrile and a mixture of acetonitrile and water.
